(19) United States
(12) Patent Application Publication
(10) Pub. No.: US 2025/0303866 A1
(43) Pub. Date: Oct. 2, 2025

(54) VIRTUAL IMAGE DISPLAY DEVICE

(71) Applicant: DENSO CORPORATION, Kariya-city (JP)

(72) Inventors: Kentaro KAJITA, Kariya-city (JP); Yoichi NARUSE, Kariya-city (JP); Yuji KAWAHARA, Kariya-city (JP); Kohji OHYAMA, Kariya-city (JP)

(21) Appl. No.: 19/233,743

(22) Filed: Jun. 10, 2025

Related U.S. Application Data
(63) Continuation of application No. PCT/JP2023/041723, filed on Nov. 21, 2023.

(30) Foreign Application Priority Data
Dec. 16, 2022 (JP) 2022-201443

(51) Int. Cl. B60K 35/81; B60K 35/233; B60K 35/234; B60K 35/28

(52) U.S. Cl. CPC B60K 35/81; B60K 35/233; B60K 35/234; B60K 35/28; B60K 2360/166; B60K 2360/178; B60K 2360/188; B60K 2360/31

(57) ABSTRACT

A virtual image display device is configured to display a virtual image and includes an actuator and at least one of a circuit and a processor. The actuator switches a position of a display area between a first position and a second position. The at least one of the circuit and the processor is configured to display the virtual image of a corresponding content for each of the first position and the second position according to switching of the position of the display area by the actuator. The content for the second position includes a filled background. The at least one of the circuit and the processor is configured to limit a display duration of the filled background on displaying the filled background at the second position.

### CROSS REFERENCE TO RELATED APPLICATION

The present application is a continuation application of International Patent Application No. PCT/JP2023/041723 filed on Nov. 21, 2023, which designated the U.S. and claims the benefit of priority from Japanese Patent Application No. 2022-201443 filed on Dec. 16, 2022. The entire disclosures of all the above applications are incorporated herein by reference.

### TECHNICAL FIELD

The disclosure in this specification relates to a virtual image display device configured to display a virtual image visible to an occupant of a vehicle.

### BACKGROUND ART

There is a virtual image display device equipped with a mechanism for moving the position of a view angle.

### SUMMARY

According to one aspect, a virtual image display device configured to display a virtual image that is visible from an occupant in a vehicle is provided. The virtual image display device includes an actuator and at least one of a circuit and a processor with a memory storing computer program code executable by the processor. The actuator is configured to switch a position of a display area between a first position and a second position. The at least one of the circuit and the processor may be configured to display the virtual image of a corresponding content for each of the first position and the second position according to switching of the position of the display area by the actuator. The virtual image displayed in the position of the display area, other than the first position, may follow a display rule that is associated with at least one of a type of the content or the position of the display area.

### BRIEF DESCRIPTION OF DRAWINGS

FIG. 1 is a diagram for explaining a virtual image display function of an HUD according to an embodiment of the present disclosure.

FIG. 2 is a block diagram showing the electrical configuration of a display system.

FIG. 3 is a diagram showing the positional relationship between a normal position and an upper position of a display area, along with an example of virtual images displayed in each position.

FIG. 4 is a flowchart showing the details of a display control process executed by a head-up ECU.

FIG. 5 is a diagram showing an example of a virtual image displayed in the normal position.

FIG. 6 is a diagram for explaining the details of size adjustment applied to a bar-shaped section displayed in both the normal position and the upper position.

FIG. 7 is a diagram for explaining the details of tilt adjustment applied to a linear image section displayed in both the normal position and the upper position.

FIG. 8 is a diagram showing an example of automatic brake content displayed in the upper position.

FIG. 9 is a diagram showing the details of mode changes in the automatic brake content.

FIG. 10 is a diagram showing the details of route guidance content displayed in the upper position.

FIG. 11 is a diagram showing the details of the route guidance content.

FIG. 12 is a diagram showing the details of the route guidance content.

FIG. 13 is a diagram showing the details of the route guidance content.

FIG. 14 is a diagram showing an example of FCTA content displayed in the upper position.

FIG. 15 is a diagram showing an example of pedestrian warning content displayed in the upper position.

### DESCRIPTION OF EMBODIMENTS

To begin with, examples of relevant techniques will be described.

There is a virtual image display device equipped with a mechanism for moving the position of a view angle where the virtual image is displayed. In the virtual image display device, the view angle is moved from a normal position to an overlapping position, thereby increasing a display range where a virtual image can be viewed by the occupant of the vehicle.

### SUMMARY

In the configuration, where the display area of the virtual image can be switched, the virtual image displayed in the area shifted from the normal position can become a highly noticeable display. However, the virtual image may cause annoyance to the occupant. Such annoyance from the display of virtual image may cause a distraction.

The present disclosure provides a virtual image display device that can reduce distraction caused by display of virtual images, even in a configuration where the display area of the virtual image can be switched.

To achieve the above objective, one disclosed aspect is a virtual image display device configured to display a virtual image that is visible from an occupant in a vehicle. The virtual image display device includes an actuator and at least one of a circuit and a processor with a memory storing computer program code executable by the processor. The actuator is configured to switch a position of a display area between a first position and a second position. The display area is an area on which the virtual image is displayed. The at least one of the circuit and the processor is configured to display the virtual image of a corresponding content for each of the first position and the second position according to switching of the position of the display area by the actuator. The virtual image displayed in the position of the display area, other than the first position, follows a display rule that is associated with at least one of a type of the content or the position of the display area.

In this aspect, when the actuator moves the display area from the first position to the second position, the virtual image is displayed at the second position based on the display rule that is associated with at least one of the type of the content and the position of the display area. Thus, the virtual image is prevented from causing annoyance to the occupant. As a result, even in a configuration where the display area of the virtual image can be switched, distraction caused by the display of the virtual image can be reduced.

Additionally, combinations of claims that are not explicitly stated in claims by dependency are also included in a scope of the present disclosure unless there is a particular difficulty existing in the combination.

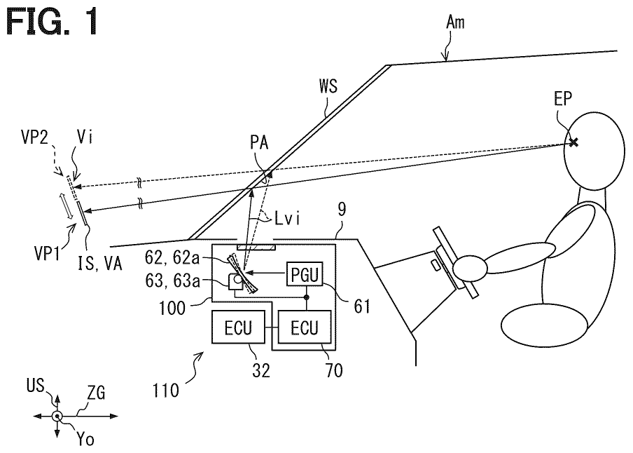

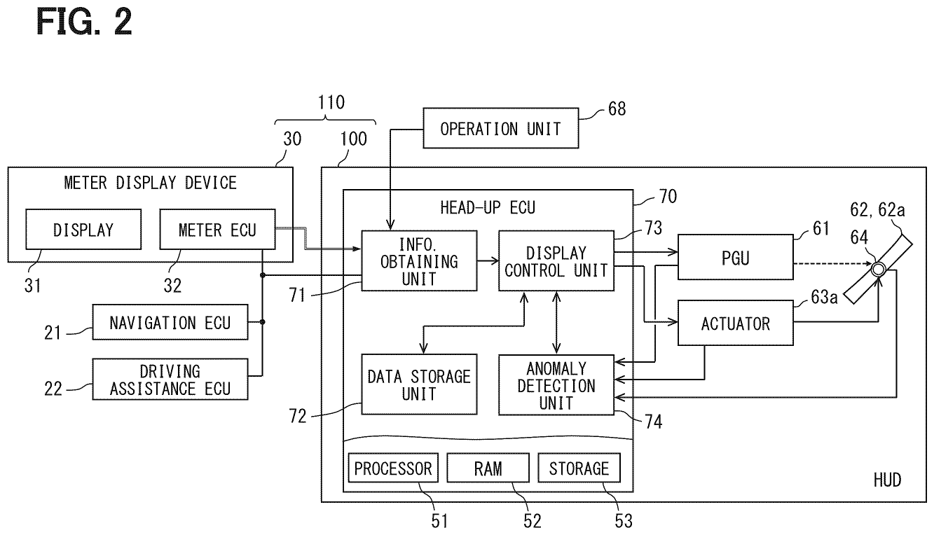

A head-up display (hereinafter referred to as HUD) 100 according to an embodiment of the present disclosure shown in FIGS. 1 and 2 is a virtual image display device configured to display a virtual image Vi. The HUD 100 forms a display system 110 together with a meter display device 30. The display system 110 is used in a vehicle Am and presents various types of information related to the vehicle Am to the driver by coordinating the virtual image display by the HUD 100 and the screen display by the meter display device 30.

The meter display device 30 and the HUD 100 are communicatively connected to a communication bus of an in-vehicle network installed in the vehicle Am. To the communication bus in the in-vehicle network, in-vehicle Electronic Control Units (ECUs), such as a navigation ECU 21 and a driving assistance ECU 22 are connected, as well as the meter display device 30 and the HUD 100. These components, connected as nodes to the communication bus, are capable of communicating with each other. Specific nodes among these ECUs may be directly electrically connected to each other, allowing communication without through the communication bus.

The meter display device 30 is one of multiple display devices installed in the vehicle Am, and the meter display device 30 provides information to the driver by displaying images on a display screen. The meter display device 30 has a structure corresponding to a combination meter and is housed in an instrument panel 9, with the display screen oriented towards the driver's seat. The meter display device 30 includes a meter display 31 and a meter ECU 32.

The meter display 31 is, for example, a liquid crystal display or an organic EL display. The meter display 31 displays images such as a speedometer image, a tachometer image, a navigation map image, and a driving assistance image on the display screen based on image data obtained from the meter ECU 32.

The meter ECU 32 is an electronic control device configured to manage user interface functions of the vehicle Am. The meter ECU 32 integrally controls display by various display devices such as the meter display 31, the HUD 100, and a center display. The meter ECU 32 mainly includes a computer equipped with a processor, RAM, storage, input/output interfaces, and a bus that connects these components. The meter ECU 32 generates video data to be provided to the meter display 31 based on various types of information output to the communication bus. The meter ECU 32 works in conjunction with a head-up ECU 70, which will be described later, to perform computational processing for virtual image display. The meter ECU 32 generates image data used for displaying the virtual image Vi and sequentially outputs the generated image data to the HUD 100.

The HUD 100 is one of the multiple display devices installed in the vehicle Am and presents information to the driver through a virtual image Vi formed in the space in front of the driver. The HUD 100 is housed in an accommodating space defined inside the instrument panel 9. The HUD 100 projects light that forms the virtual image Vi (hereinafter referred to as display light Lvi) toward a projection area PA of the windshield WS. The display light Lvi projected onto the windshield WS is reflected toward the driver's seat within the projection area PA and is perceived by the driver. The driver sees the virtual image Vi superimposed on the foreground visible through the projection area PA.

The HUD 100 includes a Picture Generation Unit (PGU) 61, a magnifying optical system 62, a displacement mechanism 63, a position sensor 64, and the head-up ECU 70.

The PGU 61 has a Liquid Crystal Display (LCD) panel and a backlight. The PGU 61 is fixed to the housing of the HUD 100 with the display surface of the LCD panel is oriented towards the magnifying optical system 62 (a plane mirror described later). The PGU 61 displays each frame image of the video data on the display surface of the LCD panel and illuminates the display surface with transmitted light from the backlight, thereby emitting display light Lvi, which is formed as the virtual image Vi, towards the magnifying optical system 62.

The magnifying optical system 62 includes at least a plane mirror and a concave mirror 62a, which are formed by depositing a metal such as aluminum on the surface of a substrate made of synthetic resin, glass, or the like. The plane mirror reflects the display light Lvi emitted from the PGU 61 towards the concave mirror 62a. The concave mirror 62a reflects and spreads the display light Lvi incident from the plane mirror, projecting the display light Lvi onto the projection area PA above.

The displacement mechanism 63 is configured to mechanically move the projection area PA on the windshield WS. The projection area PA is a range onto which the display light Lvi is projected and a range within which the virtual image Vi appears from the driver's perspective. The displacement mechanism 63 is formed of an actuator 63a and a gear unit. The displacement mechanism 63 transmits the driving force of the actuator 63a to the housing of the concave mirror 62a through the gear unit, causing the concave mirror 62a to rotate about a specified axis along a right-left direction Yo. The displacement mechanism 63 adjusts the tilt angle of the concave mirror 62a, thereby changing the emission direction of the display light Lvi from the concave mirror 62a towards the windshield WS. Through these changes in the orientation of the concave mirror 62a, the projection area PA of the display light Lvi, and consequently the position of the display area VA visible to the driver, moves at least in the vertical direction US.

More specifically, when defining a virtual range in the space where the virtual image Vi can be formed as an imaging plane IS, the display area VA is specified based on the imaginary line connecting an eye point EP of the driver and the outer edge of the imaging plane IS. The display area VA represents a view angle range within which the virtual image Vi is displayed as seen from the eye point EP. In the HUD 100, the horizontal view angle (for example, approximately 6 degrees) in the horizontal direction (i.e., the right-left direction Yo) is larger than the vertical view angle (for example, approximately 2 degrees) in the vertical direction (i.e., the up-down direction US).

The displacement mechanism 63 displaces the position of the display area VA along the up-down direction US of the vehicle Am, thereby moving a forward range overlapping with the display area VA in the front-rear direction ZG. As an example, when the displacement mechanism 63 positions the display area VA downward (for example, at a depression angle of approximately 4 degrees), the range of 10 to 20 meters ahead falls within the range of the display area VA. Conversely, when the displacement mechanism 63 positions the display area VA upward (for example, at a depression angle of approximately 2 degrees), the range of approximately 20 to 60 meters ahead falls within the range of the display area VA.

Here, the front-rear direction ZG and the right-left direction Yo are defined based on a vehicle Am that is stationary on a horizontal plane. Specifically, the front-rear direction ZG is defined as the longitudinal direction (the travelling direction) of the vehicle Am. Additionally, the right-left direction Yo is defined as the width direction of the vehicle Am. Furthermore, the up-down direction US is defined as the vertical direction of the horizontal plane specified by the front-rear direction ZG and the right-left direction Yo. Note that, for the sake of simplicity in description, the notation of the symbols indicating each direction may be omitted as appropriate.

The position sensor 64 is provided integrally with the actuator 63a or a gear unit. The position sensor 64 electrically or magnetically detects the tilt angle of the concave mirror 62a, which is adjusted by the displacement mechanism 63. The position sensor 64 continuously outputs signals indicating the current tilt angle of the concave mirror 62a to the head-up ECU 70.

The head-up ECU 70 is a controller of the HUD 100 that integrally controls the PGU 61 and the actuator 63a. The head-up ECU 70 mainly includes a computer equipped with a processor 51, RAM 52, storage 53, input/output interfaces, and a bus connecting these components. The head-up ECU 70 further includes a drive circuit for driving the LCD panel, the backlight, and the actuator 63a, as well as a detection circuit for acquiring output signals from the position sensor 64.

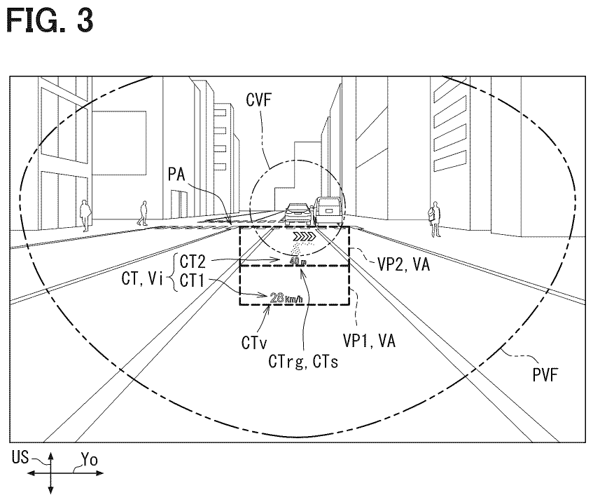

The head-up ECU 70 changes contents CT (see FIG. 3) to be displayed as a virtual image Vi in association with the position of the display area VA. Specifically, the head-up ECU 70 controls the actuator 63a of the displacement mechanism 63 to switch the position of the display area VA, where the virtual image Vi is displayed, among multiple positions including a normal position VP1 and an upper position VP2. The head-up ECU 70 displays a corresponding virtual image Vi for each of the normal position VP1 and the upper position VP2, according to switching of the display area VA by the actuator 63a.

The normal position VP1 is the position of the display area VA where the virtual image Vi is displayed in a peripheral vision PVF of the driver (see FIG. 3). The normal position VP1 is defined as being lower than the upper position VP2. The normal position VP1 is the reference position of the display area VA and corresponds to a constant position that is used for a longer duration compared to the upper position VP2. In the display area VA of the normal position VP1, a content CT indicating vehicle information, such as a speedometer CTv (see FIG. 3), is displayed. In the following description, the content CT associated with the normal position VP1 will be referred to as a first content CT1 (see FIG. 3). The driver can recognize the virtual image Vi of the first content CT1 displayed in the normal position VP1 at the timing when they want to obtain information.

The upper position VP2 is the position of the display area VA where the virtual image Vi is displayed to at least partially overlap with the central vision CVF of the driver (see FIG. 3). The upper position VP2 is defined above the normal position VP1 such that the upper position VP2 does not overlap with the normal position VP1. The display area VA is moved from the normal position VP1 to the upper position VP2 when a specific event that should be notified to the driver occurs. Within the display area VA in the upper position VP2, a content related to an event, such as a route guidance content CTrg (see FIG. 3) and a pedestrian notification content, is displayed. In the following description, the content CT associated with the upper position VP2 will be referred to as a second content CT2 (see FIG. 3). The driver can recognize the virtual image Vi of the second content CT2 displayed in the upper position VP2 without significantly diverting their gaze from the front at a timing when an event occurs.

The relative positional relationship between the normal position VP1 and the upper position VP2 may be changed as appropriate. For example, the lower edge of the upper position VP2 may be in contact with the upper edge of the normal position VP1, or the lower edge of the upper position VP2 may be slightly separated upward from the upper edge of the normal position VP1. Furthermore, the display area VA of the upper position VP2 and the display area VA of the normal position VP1 may partially overlap.

To realize the virtual image display method described so far, the head-up ECU 70 executes a program (virtual image display program) stored in the storage 53 with the processor 51, constructing multiple functional units. Specifically, the head-up ECU 70 includes functional units such as an information obtaining unit 71, a data storage unit 72, a display control unit 73, and an anomaly detection unit 74.

The information obtaining unit 71 is a functional unit configured to obtain information related to virtual image display. The information obtaining unit 71 is connected to the communication bus and the meter ECU 32. The information obtaining unit 71 obtains route information provided by the navigation ECU 21, target information around the vehicle and control status information provided by the driving assistance ECU 22, through the communication bus. Image data for the virtual image display generated by the meter ECU 32 is sequentially input to the information obtaining unit 71.

The information obtaining unit 71 is electrically connected to an operation unit 68. The operation unit 68 is a switch operated by the driver for adjusting the position of the display area VA and for switching the display of the virtual image Vi on and off. The operation unit 68 may be a dedicated switch provided on the instrument panel 9, a steering switch provided on the steering wheel, a center display with a touch panel function, and/or a voice input device that detects speech by the driver. When the operation unit 68 is operated by the driver in the vehicle Am, the information obtaining unit 71 obtains the input information entered into the operation unit 68. The information obtaining unit 71 provides the obtained input information to the display control unit 73, and the display control unit 73 adjusts the position of the display area VA and switches on and off of the virtual image display according to the operation by the driver.

The data storage unit 72 is a storage area storing multiple pieces of data referenced by the display control unit 73. The data storage unit 72 may be a storage area allocated within the RAM 52 or a part of the storage area within the storage 53. The data storage unit 72 includes a lookup table, and mirror position data and graphic data associated with the normal position VP1 and the upper position VP2 such that the display control unit 73 can refer to the lookup table, the mirror position data, and the graphic data.

The lookup table records information indicating the correspondence between the positions of the display area VA and the contents CT. The lookup table also records information that links the type of malfunction occurring in the HUD 100 with the corresponding avoidance method. The mirror position data for the normal position VP1 is information that specifies the angular position of the concave mirror 62a when setting the display area VA to the normal position VP1. The mirror position data for the upper position VP2 is information that specifies the angular position of the concave mirror 62a when setting the display area VA to the upper position VP2. Each mirror position data may be adjustable by the driver to align the position of the eye point EP of the driver. The graphic data for the normal position VP1 is image data (material data) used when the display area VA is in the normal position VP1. The graphic data for the upper position VP2 is image data (material data) used when the display area VA is in the upper position VP2.

The display control unit 73 integrally controls the PGU 61 and the actuator 63a. The display control unit 73 generates video data and control signals to be output to the PGU 61, and drive signals to be output to the actuator 63a. The display control unit 73 selects the content CT to be displayed as the virtual image Vi and controls the position of the display area VA according to the selected content.

Specifically, the display control unit 73 refers to the lookup table in the data storage unit 72 based on the information acquired by the information obtaining unit 71, and selects the content CT to be displayed as a virtual image and the position of the display area VA. Based on the selected content CT, the display control unit 73 extracts the image material data used to generate video data from the RAM 52 or the storage 53. The display control unit 73 appropriately combines the image data generated from the material data with the image data provided by the meter ECU 32 to generate each frame image of the video data. The display control unit 73 sequentially outputs the video data formed of a large number of consecutive frame images, to the PGU 61.

The display control unit 73 displays the virtual image Vi of the content CT associated with each of the normal position VP1 and the upper position VP2 according to switching of the position of the display area VA by the displacement mechanism 63. When the display control unit 73 determines to move the display area VA, the display control unit 73 switches the content CT displayed as a virtual image in relation to the start or end of the drive of the actuator 63a.

The anomaly detection unit 74 is connected to the PGU 61, the actuator 63a, and the position sensor 64, and detects various anomalies occurring in the HUD 100, such as displacement anomalies of the display area VA and video anomalies. Specifically, the anomaly detection unit 74 detects circuit anomalies in the head-up ECU 70 and software anomalies in the virtual image display program, as well as anomalies in the PGU 61 and the actuator 63a, and malfunctions of the gear unit. The display control unit 73 provides, when detecting an anomaly in the HUD 100, information indicating the detection of the anomaly (hereinafter referred to as anomaly detection information) and information indicating the type of the detected anomaly (hereinafter referred to as anomaly type information) to the display control unit 73.

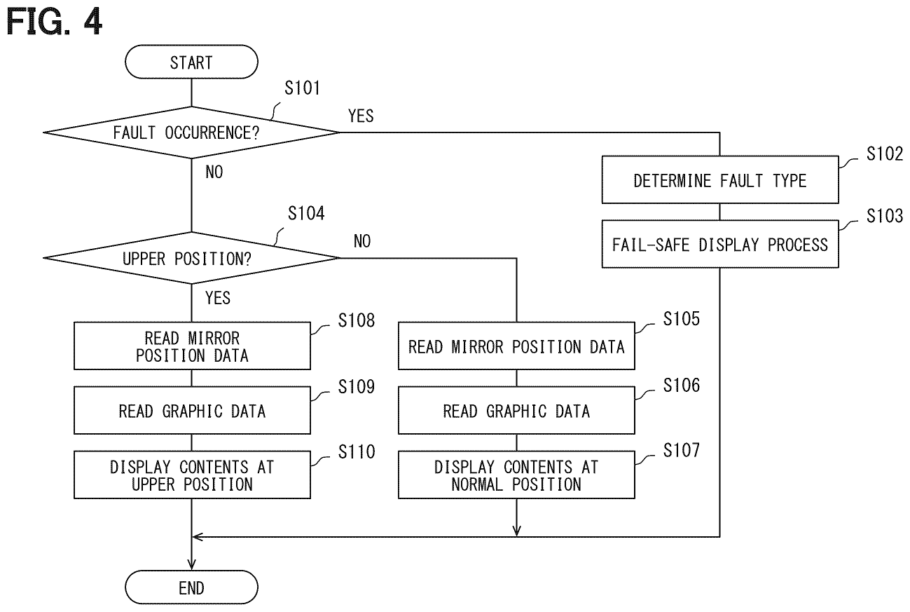

The details of the display control process executed mainly by the display control unit 73 will be described below with reference to FIGS. 1, 2, and 4. The display control unit 73 starts the display control process shown in FIG. 4 based on start of the power supply to the head-up ECU 70 after the start of the power supply to the HUD 100. In the display control process, faults related to the virtual image display are continuously monitored. The display control process is repeatedly executed until the power supply to the head-up ECU 70 is turned off.

In step S101 of the display control process, the display control unit 73 determines whether a fault has occurred in the virtual image display based on the presence or absence of anomaly detection information from the anomaly detection unit 74. When anomaly detection information has been obtained and the display control unit 73 determines that a fault has occurred (S101: YES), the display control unit 73 determines the type of the fault in step S102 based on anomaly type information obtained from the anomaly detection unit 74.

In step S103, the display control unit 73 selects a predetermined avoidance method associated with the identified fault type by referring to the lookup table in the data storage unit 72. Then, the display control unit 73 executes a display process (a fail-safe display process) to change the content of the virtual image according to the selected avoidance method, so as not to hinder the driver's normal operation.

On the other hand, when the anomaly detection information has not been obtained from the anomaly detection unit 74 and the display control unit 73 determines that a fault has not occurred (S101: NO), the display control unit 73 determines the position of the display area VA in S104. Specifically, the display control unit 73 selects the content CT to be displayed as a virtual image and the position of the display area VA by referring to the lookup table in the data storage unit 72 based on the information obtained by the information obtaining unit 71.

When the display control unit 73 determines to set the display area VA to the normal position VP1 (S104: NO), the display control unit 73 reads the mirror position data and graphic data associated with the normal position VP1 from the data storage unit 72 in steps S105 and S106. Then, in step S107, the display control unit 73 displays the virtual image Vi of the content CT, which has been determined to be displayed in step S104, in the normal position VP1 of the display area VA.

On the other hand, when the display control unit 73 determines to set the display area VA to the upper position VP2 (S104: YES), the display control unit 73 reads the mirror position data and graphic data associated with the upper position VP2 from the data storage unit 72 in steps S108 and S109. Then, in step S110, the display control unit 73 displays the virtual image Vi of the content CT, which has been determined to be displayed in step S104, in the upper position VP2 of the display area VA.

In the above display control process, when the selected display area VA is not the normal position VP1 (S104: YES), the display control unit 73 displays the virtual image Vi based on a display rule that is associated with at least one of the type of content CT and the position of the display area VA. When the display area VA is not the normal position VP1 includes cases where the display area VA is at the upper position VP2 and where the display area VA is moving.

The display control unit 73 displays the virtual image Vi of the content CT in a way that minimizes annoyance and distraction for the driver using the display rule. In this embodiment, the data storage unit 72 stores in advance the lookup table and graphic data corresponding to various predetermined display rules. The display control unit 73 can display the virtual image Vi with appropriately following the predetermined display rules by referring to the lookup table and graphic data. The details of the various types of display rules used in this disclosure will be described below.

### <First Display Rule>

The first display rule is associated with the upper position VP2. The first display rule is applied to the virtual image Vi displayed in the upper position VP2. By using the first display rule, the mode of the virtual image Vi displayed in the upper position VP2 is more limited than the mode of the virtual image Vi displayed in the normal position VP1. As a result, the virtual image Vi displayed in the upper position VP2 is less likely to distract the driver.

### (Limitations on Text Information)

The display control unit 73 follows the first display rule for displaying text information MJ (see FIG. 8) in the upper position VP2. The text information MJ includes an image section that informs about active applications as well as an image section that indicates the vehicle speed and/or street names and changes in real-time. The text information MJ displayed in the upper position VP2 is limited in at least one of the number of characters and the size of each character compared to the text information MJ displayed in the normal position VP1, based on the first display rule. In this embodiment, the display control unit 73 limits both the number of characters and the size of each character in the text information MJ displayed in the upper position VP2. As a result, the amount of information (volume) of the text information MJ in the upper position VP2 is reduced compared to that in the normal position VP1.

Specifically, the text information MJ displayed in the normal position VP1 is not subject to any limitations on the number of characters. On the other hand, the number of characters in the text information MJ displayed in the upper position VP2 is subject to limitations, such as being less than 10 characters or being limited to the number of characters that can be written in a single line. Furthermore, only the lower limit of the character size may be set for the text information MJ displayed in the normal position VP1. On the other hand, both the lower and upper limits of the character size may be set for the text information MJ displayed in the upper position VP2. The lower limit of the character size in the upper position VP2 is set to be larger than the lower limit of the character size in the normal position VP1. The upper limit of the character size may be defined based on the ratio of the vertical dimension to the horizontal dimension of the display area VA. Furthermore, in the upper position VP2, the spacing between characters is secured to be wider than that in the normal position VP1.

### (Limitations on Filled Background)

The display control unit 73 follows the first display rule for displaying a filled background NH (see FIG. 8) in the upper position VP2. The text information MJ is displayed superimposed on the filled background NH. The filled background NH is an image section that highlights the text information MJ and is described in a display color different from that of the text information MJ. As an example, the color of the filled background NH is set to a chromatic and high-brightness display color (e.g., red). On the other hand, the color of the text information MJ is set to an achromatic and high-brightness display color (e.g., white).

When the display control unit 73 displays the text information MJ on the filled background NH in the upper position VP2, the display control unit 73 emphasizes the outlines Ri of the characters included in the text information MJ by outlining each character in the text information in a color different from that of the filled background NH. The color of the outlines Ri may be set to an achromatic and low-brightness display color. The outlines Ri create a visual effect that enhances the contrast in brightness between the filled background NH and the text information MJ. As a result, the readability of the text information MJ can be improved.

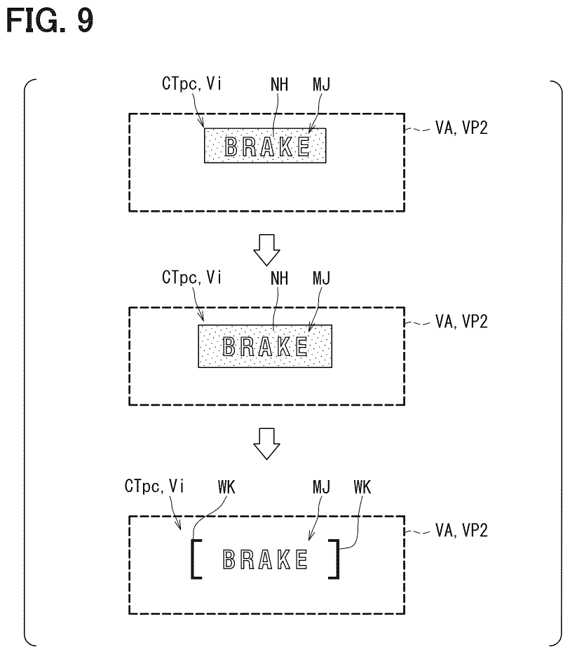

The display control unit 73 limits the duration during which the filled background NH is kept displayed in the upper position VP2 based on the first display rule (see FIG. 9). Specifically, the display control unit 73 limits the display duration of the filled background NH to an extremely short time (for example, about 0.1 seconds). The display control unit 73 ends the display of the filled background NH after a brief display of the filled background to alert the driver, ensuring that the wide range of the filled background NH does not obstruct the driver's view. The display control unit 73, while continuing the display of the text information MJ, replaces the filled background NH with a frame-shaped image WK (see the lower part of FIG. 9) displayed on both the left and right sides of the text information MJ. The frame-shaped image WK is linearly described in the same display color as the filled background NH not to obstruct the driver's forward view.

### <Second Display Rule>

The second display rule is associated with the display area VA in motion. The second display rule is applied to the virtual image Vi when the displacement mechanism 63 moves the display area VA from the normal position VP1 to the upper position VP2. Based on the second display rule, attention to the display area VA during the movement of the display area VA and optical illusions before and after the movement of the display area VA are suppressed.

### (Display Limitations During Movement)

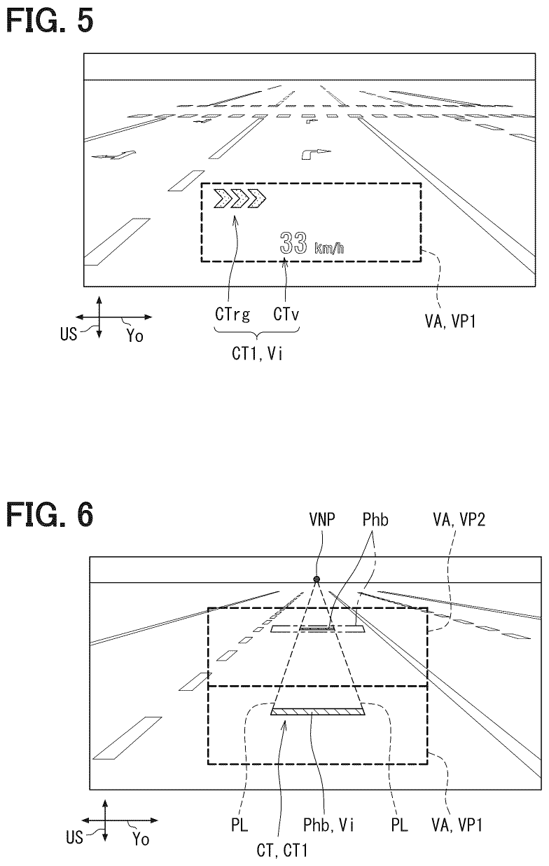

When the displacement mechanism 63 moves the display area VA from the normal position VP1 to the upper position VP2, the display control unit 73 stops displaying the virtual image Vi that is displayed in the normal position VP1 before the movement of the display area VA starts, based on the second display rule. As an example, when the speedometer CTv and route guidance content CTrg are displayed in the normal position VP1 as the first content CT1, the display control unit 73 hides these virtual images Vi first and then starts the movement of the display area VA with the displacement mechanism 63 (see FIG. 5). After the display area VA has moved to the upper position VP2, the display control unit 73 displays the speedometer CTv and route guidance content CTrg again.

Similarly, when the displacement mechanism 63 moves the display area VA from the upper position VP2 to the normal position VP1, the display control unit 73 may stop displaying the virtual images Vi displayed in the upper position VP2 before the movement of the display area VA starts. In this case as well, the display control unit 73 displays the content CT that was temporarily hidden again after the display area VA has moved to the normal position VP1.

### (Size Adjustment in Perspective Direction)

When the display control unit 73 displays common content CT before and after the movement from the normal position VP1 to the upper position VP2, the display control unit 73 adjusts the display size of the virtual images Vi while the relationship between the virtual image Vi and the vanishing point VNP in the foreground is maintained between the normal position VP1 and the upper position VP2, based on the second display rule. As an example, when the first content CT1, which includes a bar-shaped image section Phb extending in the horizontal direction (in the right-left direction Yo), is displayed in the normal position VP1 and the display area is moved to the upper position VP2, the display control unit 73 reduces the bar-shaped image section Phb in the perspective direction and displays the reduced bar-shaped image section in the upper position VP2 (see FIG. 6). The bar-shaped image section Phb is included, for example, in the content CT indicating operation of ACC (Adaptive Cruise Control) and is displayed as an image section representing a preceding vehicle.

If the bar-shaped image section Phb with the same display size is displayed in both the normal position VP1 and the upper position VP2 (see the two-dot chain line in FIG. 6), the bar-shaped image section Phb would appear enlarged relative to the foreground, potentially causing unintended emphasis on the foreground. Thus, the display control unit 73 adjusts the size of the bar-shaped image section Phb in the upper position VP2 to be smaller compared to that in the normal position VP1, in accordance with the perspective reference lines PL converging at the vanishing point VNP (see the dashed lines in FIG. 6). By adjusting the display size in this manner, unintended emphasis due to the Ponzo illusion is avoided.

### (Tilt Adjustment Considering Vanishing Point)

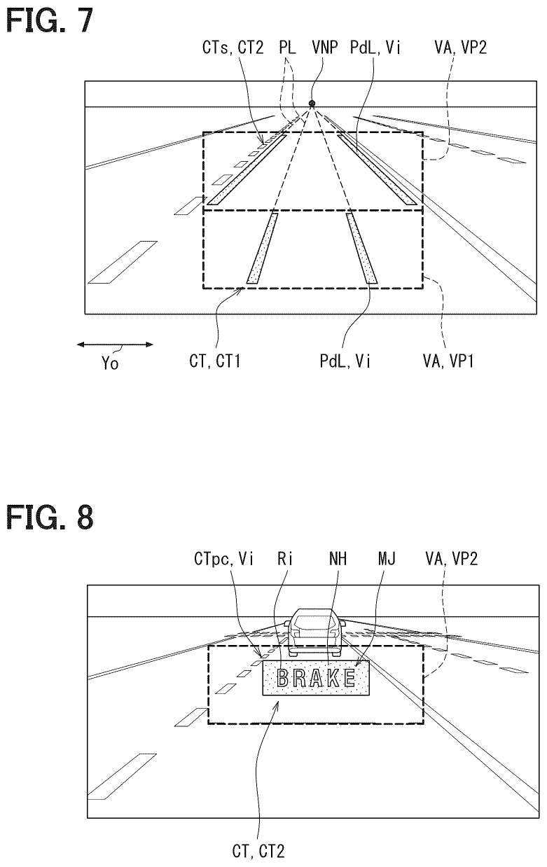

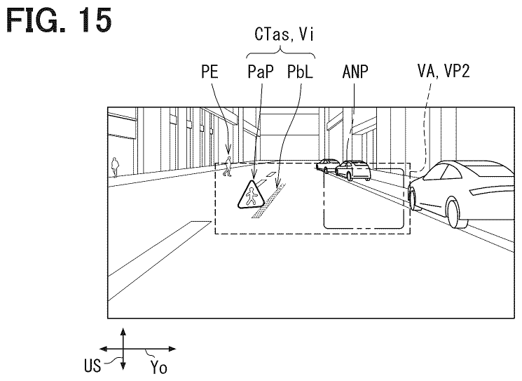

When the display control unit 73 displays a content CT that includes a linear image section PbL extending toward the vanishing point VNP in the foreground, and the content CT including the linear image section PbL is displayed both before and after movement of the display area VA from the normal position VP1 to the upper position VP2, the display control unit 73 follows the second display rule for displaying the linear image section PbL. The display control unit 73 adjusts the tilt of the linear image section PbL while the orientation of the linear image section PbL towards the vanishing point VNP is maintained between the normal position VP1 and the upper position VP2 (see FIG. 7). As an example, the linear image section PbL is an image section that emphasizes the lane markings of the lane where the vehicle is travelling in both the first content CT1 and the second content CT2 (see also FIG. 15).

The display control unit 73 adjusts the tilt of the linear image section PbL according to the perspective reference line PL, which converges at the vanishing point VNP (see dashed line in FIG. 7), based on the position of the display area VA. As a result, the linear image section PbL of the first content CT1 is displayed in a more vertical orientation compared to the linear image section PbL of the second content CT2. In other words, the linear image section PbL of the second content CT2 is displayed in a more horizontal orientation compared to the linear image section PbL of the first content CT1.

It should be noted that the perspective reference line PL in FIGS. 6 and 7 is a virtual line provided for explanatory purposes and is not actually displayed. Additionally, the size adjustment in the perspective direction and the tilt adjustment considering the vanishing point VNP are display rules that are associated not only to the position of the display area VA but also to the type of content CT.

### <Third Display Rule>

The third display rule is associated to both the type of content CT and the position of the display area VA. The third display rule is followed by AR (Augmented Reality) content CTs that are displayed in the upper position VP2 of the display area (see FIG. 3). The display position of the AR content CTs is associated with a specific superimposition target in the foreground, and is seemingly fixed relative to the position of the specific superimposition target, allowing the AR content CTs to follow the specific superimposition target corresponding to a movement of driver's eye line. The display control unit 73 identifies specific positions on the road surface, a preceding vehicle, pedestrians, and road signs as superimposition targets. The display control unit 73 continuously maintains the relative positional relationship among the eye point EP of the driver, the superimposition targets in the foreground, and the AR content CTs.

(Overlap Limitations with Superimposition Target)

When displaying the AR content CTs in the upper position VP2, the display control unit 73 follows the third display rule to avoid displaying the AR content CTs to overlap with the superimposition targets which the driver should pay attention to. The display control unit 73 superimposes the AR content CTs at a position slightly offset from the superimposition target.

As an example, the second content CT2 (see FIG. 7) including the linear image section PbL is displayed as the AR content CTs whose superimposed target is the lane markings of the vehicle's lane. Specifically, the content CT indicating LDW (Lane Departure Warning) operation and LTC (Lane Trace Control) operation by the driving assistance ECU 22 is displayed as AR content CTs that includes the linear image section PbL. In this case, the display control unit 73 superimposes the linear image section PbL inward of the lane markings to ensure that the linear image section PbL does not overlap with the lane markings in the foreground. As a result, from the driver's perspective, the overlapping area between the AR content CTs and the superimposition target is zero. The display control unit 73 may allow a slight overlap between the AR content CTs and the superimposition target. In this case, the overlapping area is kept below a predetermined value. The above-mentioned overlap limitations can prevent excessive attention from being drawn to the superimposition target and also suppresses the driver's unintended motivation to align the AR content CTs with the superimposition target.

### <Fourth Display Rule>

The fourth display rule is associated with both the type of content and the position of the display area VA. The fourth display rule is followed by specific types of content CT displayed in the upper position VP2 of the display area VA, for reducing the cognitive load of the content CT and shortening the driver's recognition, decision-making, and operation time. Based on the fourth display rule, the virtual image Vi is displayed in a manner that considers correct perception, intuitive understanding, and correlation with external vehicle information.

### (Automatic Braking Content)

When displaying the automatic braking content CTpc shown in FIGS. 8 and 9 in the upper position VP2, the display control unit 73 follows the fourth display rule for the automatic braking content CTpc. The automatic braking content CTpc is a content CT that informs the driver of execution of Autonomous Emergency Braking by the driving assistance ECU 22 (see FIG. 2). The display control unit 73 displays the virtual image Vi, which consists of the text information MJ “BRAKE” superimposed on the filled background NH, as the automatic braking content CTpc in the upper position VP2 of the display area.

The display control unit 73 follows the fourth display rule and the first display rule described above for displaying the automatic braking content CTpc. Specifically, when displaying the automatic braking content CTpc, the display control unit 73 applies visual effects such as blinking and magnification to the virtual image Vi so that the driver can quickly notice the warning (see the upper part of FIG. 9).

In addition, the display control unit 73 enhances the readability of the text information MJ by adding dark-colored outlines Ri to each character of the text information MJ, while limiting the number of characters and the size of each character in the text information MJ (see FIG. 8 and the middle section of FIG. 9). After the display control unit 73 alerts the driver, the display control unit 73 stops displaying the filled background NH and displays the frame-shaped image WK, in order to avoid obstructing the driver's forward view (see the lower part of FIG. 9).

### (Route Guidance Content)

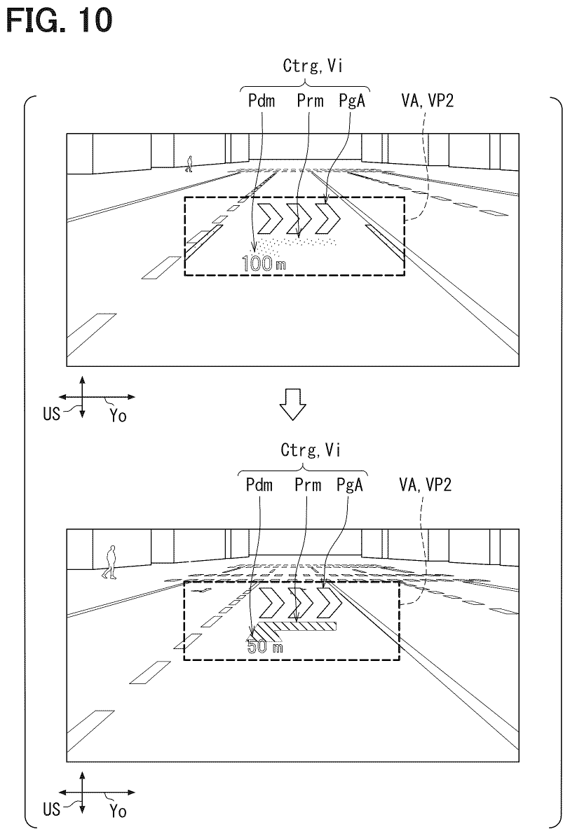

When the display control unit 73 displays the route guidance content CTrg in the upper position VP2, the display control unit 73 follows the fourth display rule for the route guidance content CTrg, as shown in FIGS. 10 to 13. The route guidance content CTrg is a so-called turn-by-turn display. The route guidance content CTrg is displayed based on route information provided by the navigation ECU 21 (see FIG. 2) and is used for route guidance at guidance points. Specifically, the route guidance content CTrg provides the driver with information on the positions of the destination and waypoints, the directions for right and left turns, as well as information on branching and merging points.

The route guidance content CTrg displayed in the upper position VP2 includes elements such as an arrow image section PgA, a road marking section Prm, and a remaining distance meter Pdm. The arrow image section PgA includes multiple arrow-shaped image elements aligned in the right-left direction Yo. The arrow image section PgA indicates the traveling direction of the vehicle at guidance points (for example, intersections) with the image elements, pointing in the forwarding direction the vehicle should take (in FIG. 10, the right direction). The road marking section Prm is positioned below the arrow image section PgA. The road marking section Prm is depicted in an L-shape and is superimposed on the forward road surface to guide the planned route of the vehicle at the guidance point (in FIG. 10, a right turn). The remaining distance meter Pdm indicates the remaining distance to the guidance point in numerical values based on the route information.

The display control unit 73 moves the display area VA from the normal position VP1 (see FIG. 5) to the upper position VP2 at the timing just before the remaining distance to the guidance point becomes approximately 100 meters. When the route guidance content CTrg (see FIG. 5) is displayed in the normal position VP1, the display control unit 73 stops displaying the route guidance content CTrg in the normal position VP1 before the movement of the display area VA starts, in accordance with the first display rule. The display control unit 73 may fade out the route guidance content CTrg towards the guidance point (the vanishing point VNP, see FIG. 6).

The display control unit 73 moves the display area VA to the upper position VP2 and displays the route guidance content CTrg in the upper position VP2 of the display area VA (see the upper part of FIG. 10). The display control unit 73, based on the fourth display rule, limits the changes in the mode of the route guidance content CTrg until the remaining distance from the vehicle Am (see FIG. 1) to the guidance point falls below a predetermined value. As an example, the display control unit 73 keeps the mode of the route guidance content CTrg fixed until the remaining distance is less than 50 meters. Then, when the remaining distance is less than 50 meters, the display control unit 73 changes the mode of the route guidance content CTrg according to the remaining distance from the vehicle Am to the guidance point.

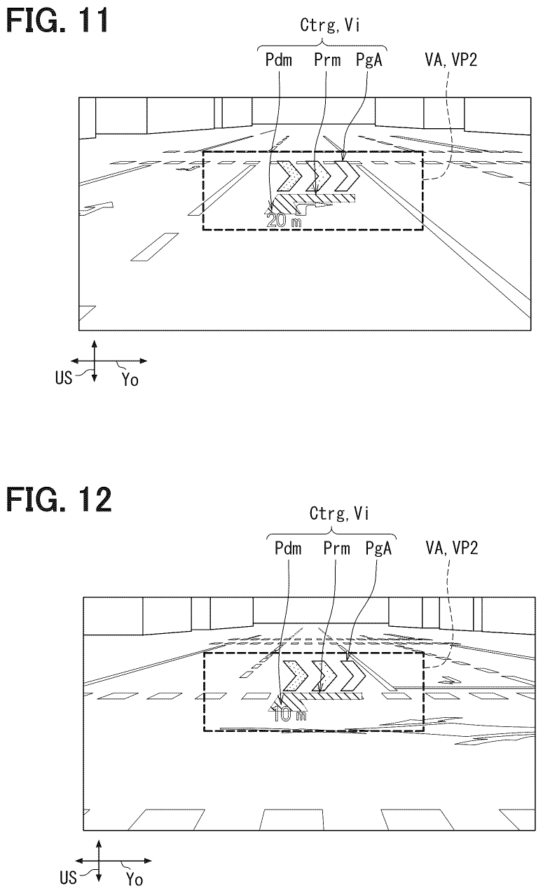

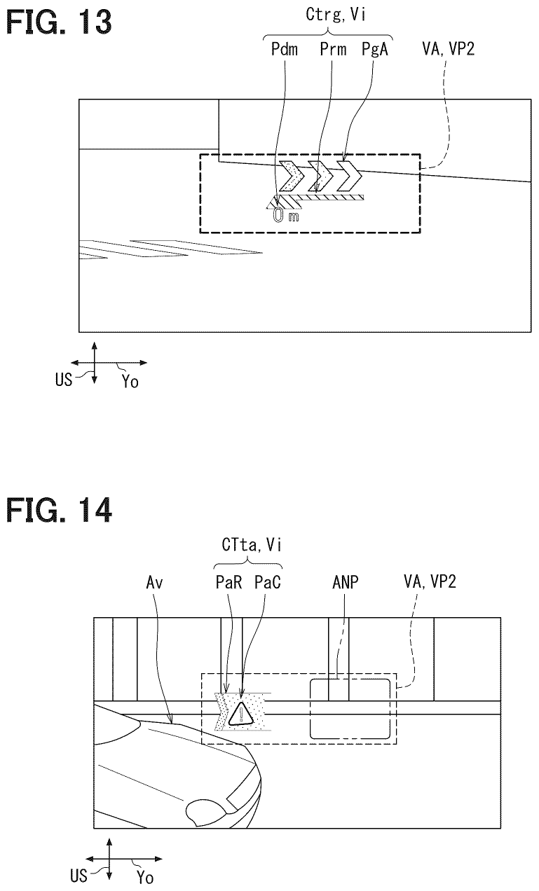

The display control unit 73 fixes the numerical value of the remaining distance meter Pdm at the initial “100 m” until the remaining distance becomes less than 50 meters. Then, at the timing when the remaining distance reaches 50 meters, the display control unit 73 changes the numerical value of the remaining distance meter Pdm from “100 m” to “50 m” (see the bottom of FIG. 10). From this point onward, the display control unit 73 continuously decreases the numerical value of the remaining distance meter Pdm until the vehicle Am reaches the guidance point (see FIGS. 11 and 12). Then, after the vehicle Am reaches the guidance point, the display control unit 73 continues to display the remaining distance meter Pdm indicating the numerical value “0 m” until the route guidance ends (see FIG. 13).

Additionally, the display control unit 73 does not change the display color and shape of the arrow image section PgA and the road surface marking section Prm until the remaining distance becomes less than 50 meters. At the timing when the remaining distance becomes less than 50 meters, the display control unit 73 starts an animation display in which the display color of each image element of the arrow image section PgA sequentially changes in the direction in which the vehicle Am is turning right or left (see FIGS. 11 and 12). The display control unit 73 continues the animation display of the arrow image section PgA until the vehicle Am completes its right or left turn (see FIG. 13).

Furthermore, at the timing when the remaining distance becomes less than 50 meters, the display control unit 73 starts to change the mode of the route guidance content CTrg. The display control unit 73 changes at least one of the display position and display color of the route guidance content CTrg, or displays an animation to assist the driver to understand the remaining distance. Specifically, at the timing when the remaining distance becomes less than 50 meters, the display control unit 73 changes the display color of the road surface display section Prm from an achromatic color (e.g., gray) to a chromatic color (e.g., blue or light blue) that is the same as or similar to the arrow image section PgA (see FIG. 11). Furthermore, as the vehicle Am approaches the guidance point, the display control unit 73 continuously changes the shape of the road surface display section Prm (see FIGS. 11 to 13).

The route guidance content CTrg described above can visually indicate the sense of distance to the guidance point by transitioning from a state with limited mode changes to a state that utilizes mode changes. Furthermore, by means of animation display of the arrow image section PgA, the timing for actions such as right or left turns is clearly indicated to the driver. Additionally, since all virtual images Vi are erased when the display area VA is moved, the annoyance caused by switching the display area VA is reduced.

### (FCTA Content)

When the display control unit 73 displays a FCTA (Front Cross Traffic Alert) content CTta in the upper position VP2 as shown in FIG. 14, the display control unit 73 follows the fourth display rule. The FCTA content CTta is a notification content that alerts the presence of other vehicles (hereinafter referred to as approaching vehicles Av) approaching from the front left or right among the risk objects around the vehicle Am (see FIG. 1). The FCTA content CTta is displayed based on the recognition of approaching vehicles Av by the driving assistance ECU 22 (see FIG. 2), for example, in scenes such as when entering an intersection.

The FCTA content CTta is displayed on the side where the approaching vehicle Av is present in the right-left direction Yo of the display area VA. Specifically, when the approaching vehicle Av is approaching from the left side of the vehicle, the FCTA content CTta is displayed in the area to the left of the center of the display area VA (see FIG. 14). On the other hand, when the approaching vehicle Av is approaching from the right side of the vehicle, the FCTA content CTta is displayed in the area to the right of the center of the display area VA.

When displaying the FCTA content CTta in the upper position VP2, the display control unit 73 follows the fourth display rule and sets a non-display area ANP in the display area VA that has moved from the normal position VP1 (see FIG. 3) to the upper position VP2. The non-display area ANP is an area in which a virtual image Vi is not displayed. The display control unit 73 sets a right area of the display area VA from the center of the display area VA as a non-display area ANP when a vehicle Av is approaching from the left side of the vehicle (see FIG. 14). Conversely, when a vehicle Av is approaching from the right side of the vehicle, the display control unit 73 sets an area of the display area VA from the center of the display area VA as the non-display area ANP.

In addition, based on the fourth display rule, the display control unit 73 limits the number of display colors available for the virtual image Vi. Furthermore, the display control unit 73 displays the FCTA content CTta in a manner that differentiates the FCTA content CTta from the route guidance content CTrg (see FIG. 5 and FIG. 10, etc.) by using different display colors and shapes. Specifically, the display control unit 73 displays the FCTA content CTta, which includes elements such as an approaching vehicle warning icon PaC and a surface arrow image section PaR, in a display color such as yellow or amber, which is different from that of the route guidance content CTrg (e.g., blue or light blue).

The approaching vehicle warning icon PaC may be an exclamation mark “!” The approaching vehicle warning icon PaC is an image section where the symbol “!” is enclosed in a triangular frame to alert the driver to the presence of an approaching vehicle Av. The approaching vehicle warning icon PaC is drawn in an inclined posture where the approaching vehicle warning icon PaC appearing to recede toward the center, by rotating the approaching vehicle warning icon PaC around an axis along the vertical direction US. The approaching vehicle warning icon PaC is displayed superimposed on the surface arrow image section PaR.

The surface arrow image section PaR has a shape that extends in a band-like manner along the right-left direction Yo. The surface arrow image section PaR employs a gradient representation in the right-left direction Yo. The surface arrow image section PaR is displayed with high saturation and high brightness on the side closer to the approaching vehicle Av (the left side in FIG. 14) along the right-left direction Yo. Additionally, through an animation display that flows starting from the side closer to the approaching vehicle Av, the relative position of the approaching vehicle Av is emphasized and indicated to the driver.

As described above, the surface arrow image section PaR adopts an expression that combines a gradient representation with an arrow shape to clearly differentiate the surface arrow image section PaR from the arrow image section PgA of the route guidance content CTrg (see FIGS. 5 and 10, etc.). In addition, the approaching vehicle warning icon PaC superimposed on the surface arrow image section PaR instantaneously notifies the driver of a caution alert. As a result, the FCTA content CTta becomes less likely to be mistaken for the route guidance content CTrg.

### (Avoidance Assistance Content)

When the display control unit 73 displays the avoidance assistance content CTas in the upper position VP2 as shown in FIG. 15, the display control unit 73 follows the fourth display rule. The avoidance assistance content CTas is a notification content that alerts the driver to risk objects around the vehicle Am (see FIG. 1), such as pedestrians PE or cyclists approaching from the front left or right. The avoidance assistance content CTas is displayed when a pedestrians PE is recognized by the driving assistance ECU 22 (see FIG. 2), and the driving assistance ECU 22 executes steering assistance control or deceleration assistance control to avoid the pedestrians PE.

The avoidance assistance content CTas is displayed on the side in the display area VA in the right-left direction Yo from the center which is closer to the pedestrian PE. Specifically, when a pedestrian PE is approaching from the left side of the vehicle, the avoidance assistance content CTas is displayed in the area to the left of the center of the display area VA (see FIG. 15). On the other hand, when a pedestrian PE is approaching from the right side of the vehicle, the avoidance assistance content CTas is displayed in the area to the right of the center of the display area VA.

When the display control unit 73 displays the avoidance assistance content CTas in the upper position VP2, the display control unit 73 sets the non-display area ANP within the display area VA that has been moved to the upper position VP2, based on the fourth display rule. When a pedestrian PE is approaching from the left side of the vehicle, the display control unit 73 sets the area on the right side of the center of the display area VA as the non-display area ANP (see FIG. 15). On the other hand, if a pedestrian PE is approaching from the right side of the vehicle, the display control unit 73 sets the area on the left side of the center of the display area VA as the non-display area ANP.

Furthermore, based on the fourth display rule, the display control unit 73 limits the number of display colors available for the virtual image Vi in the upper position VP2 after moving the display area VA from the normal position VP1 (see FIG. 3) to the upper position VP2. As an example, the display control unit 73 displays the avoidance assistance content CTas, which includes the pedestrian warning icon PaP and the linear image section PbL, in a single color (for example, yellow or amber).

The pedestrian warning icon PaP is an image section that surrounds an icon mimicking a pedestrian PE with a triangular frame, alerting the driver to the presence of the pedestrian PE. The pedestrian warning icon PaP indicates the movement direction of the pedestrian PE with minimal elements by depicting dynamic poses of the limbs in the icon and drawing the pedestrian warning icon PaP in a diagonal posture in which the pedestrian warning icon PaP recedes towards the center.

The linear image section PbL extends towards the vanishing point VNP (see FIG. 7) in the foreground. The linear image section PbL is arranged to be in contact with the lower edge of the pedestrian warning icon PaP closer to the center, thereby emphasizing and indicating the relative position of the pedestrian PE to the driver with the pedestrian warning icon PaP.

As described above, the display control unit 73 uses the avoidance assistance content CTas which appears larger, thereby making it easier for the driver to recognize the pedestrian PE. Furthermore, by setting the non-display area ANP and utilizing the pedestrian warning icon PaP displayed in a single color with a tilted posture, the avoidance assistance content CTas can instantly convey to the driver the direction from which the pedestrian PE is approaching.

### Summary of Embodiments

According to the embodiments described above, when the displacement mechanism 63 moves the display area VA from the normal position VP1, the display rules associated with at least one of the type of content CT and the position of the display area VA are applied for displaying the virtual image Vi. This can prevent the virtual image Vi from being displayed in a manner that causes annoyance to the driver or other occupants. As a result, even in a configuration that allows the display area VA of the virtual image Vi to be changed, it is possible to prevent the display of the virtual image Vi from distracting the driver or other occupants.

Additionally, in this embodiment, expression methods that reduces annoyance or attract due to fluctuations in the display area VA are adopted based on the first to fourth display rules, thereby notifying the driver or other occupants of information without causing discomfort in various situations.

Specifically, in this embodiment, the first display rule is applied when the text information MJ is displayed in the upper position VP2, which is upper than the normal position VP1. Based on the first display rule, the text information MJ is limited in at least one of the number of characters and the size of each character compared to when it is displayed in the normal position VP1. This avoids the situation where the text information MJ which takes time to read is displayed near the central vison CVF, thereby avoiding distraction.

Additionally, in this embodiment, the first display rule is applied when the filled background NH is displayed in the upper position VP2, and the display duration of the filled background NH is limited. As a result, the situation is less likely to occur where a large area of the filled background NH obstructs the driver's vision for an extended period.

Furthermore, in this embodiment, when the text information MJ is superimposed on the filled background NH and displayed in the upper position VP2, the outlines Ri of each character in the text information MJ are emphasized in a color different from that of the filled background NH. These outlines Ri improve the readability of the text information MJ. As a result, even when the text information MJ is displayed near the central vision CVF, excessive attention is less likely to occur.

In addition, based on the fourth display rule, the mode of the route guidance content CTrg used for route guidance at the guidance point (a specified position) changes according to the remaining distance from the vehicle Am to the guidance point. As a result, the route guidance content CTrg can appropriately assist the driver to recognize the remaining distance to the guidance point. As a result, the driver can pass the guidance point with appropriate guidance.

In this embodiment, the fourth display rule is applied to the FCTA content CTta and avoidance assistance content CTas, which inform about risk objects (such as approaching vehicles Av and pedestrians PE) around the vehicle Am. As a result, a non-display area ANP where the virtual image Vi is not displayed is set within the display area VA that has moved from the normal position VP1 to the upper position VP2. The setting of the non-display area ANP prevents other virtual images Vi from obstructing the visibility of the FCTA content CTta and avoidance assistance content CTas, which inform about risk objects. As a result, the driver can quickly grasp the type and relative position of the risk objects.

Furthermore, based on the fourth display rule for the FCTA content CTta and avoidance assistance content CTas, the number of display colors available for the virtual image Vi is limited in the upper position VP2 after the display area VA has moved from the normal position VP1 to the upper position VP2. Specifically, the FCTA content CTta and avoidance assistance content CTas are displayed in a single color, such as amber, to prompt caution. Such a limitation on display colors can aid the driver in instantaneously understanding the information.

Additionally, based on the fourth display rule, the FCTA content CTta, which informs about approaching vehicles Av, is differentiated from the route guidance content CTrg, which is used for route guidance at guidance points, using different display colors and shapes. Thus, it becomes less likely that the FCTA content CTta, which indicates the direction of approaching vehicles Av, will be mistaken for the route guidance content CTrg, which indicates the direction of the vehicle's travel.

In this embodiment, when the displacement mechanism 63 moves the display area VA from the normal position VP1 to the upper position VP2, the second display rule is applied and the virtual image Vi displayed in the normal position VP1 is hidden before the movement of the display area VA starts. Thus, the driver is prevented from being distracted by the virtual image Vi displayed during the movement of the display area VA, thereby avoiding discomfort for the driver.

Furthermore, in this embodiment, when common section of content CT is displayed before and after the movement from the normal position VP1 to the upper position VP2, the second display rule is applied and the display size of the virtual image Vi is adjusted so that the relationship between the virtual image Vi of the common section and the vanishing point VNP in the foreground is maintained between the normal position VP1 and the upper position VP2. Thus, it is possible to avoid the unintended emphasis caused by the content CT (for example, the bar-shaped image section Phb, etc.) when the content Ct is moved to the upper position VP2.

In addition, when displaying the content CT which includes the linear image section PbL extending toward the vanishing point VNP in the foreground both before and after the movement from the normal position VP1 to the upper position VP2, the second display rule is applied. As a result, the tilt of the linear image section PbL is adjusted so that the orientation of the linear image section PbL toward the vanishing point VNP is maintained between the normal position VP1 and the upper position VP2. This prevents the misalignment of the linear image section PbL with respect to a boundary line in the foreground from causing discomfort for the driver or other occupants.

In the above embodiment, the normal position VP1 corresponds to the “first position,” the upper position VP2 corresponds to the “second position,” the displacement mechanism 63 corresponds to an “actuator,” the HUD 100 corresponds to the “virtual image display device”, and an ECU including the display control unit 73 corresponds to a “display control device”. Furthermore, each of the FCTA content CTta and the avoidance assistance content CTas correspond to a “notification content.” (Other Embodiments)

Although one embodiment of the present disclosure has been described above, the present disclosure is not construed as being limited to the above-mentioned embodiment, and can be applied to various embodiments and combinations within a scope that does not depart from the gist of the present disclosure.

In a first modification of the above embodiment, the display of the text information MJ such as vehicle speed and street names in the upper position VP2 is restricted. Specifically, the text information MJ which changes in real-time is not displayed in the upper position VP2 of the display area VA. Furthermore, in the first modification, the filled background NH is not displayed in the upper position VP2 of the display area VA.

In a second modification of the above embodiment, the displacement mechanism 63 can displace the display area VA not only in the up-down direction US but also in the right-left direction Yo. Furthermore, the displacement mechanism 63 may position the display area VA at a location different from the normal position VP1 and the upper position VP2. Additionally, the displacement mechanism 63 may displace the entire optical unit which includes the PGU 61 and the magnifying optical system 62, relative to the housing of the HUD 100. Furthermore, the displacement mechanism 63 may displace the housing of the HUD 100 relative to the vehicle Am.

In a third modification of the above embodiment, real-time detection information of the eye point EP by a driver monitor is provided to the head-up ECU 70. The display control unit 73, in cooperation with the driver monitor, adjusts the positions of the display area VA and the display position of the virtual image Vi based on the detection information to match the current position of the eye point EP.

In the above embodiment, the content CT to which each display rule is applied is not limited to the aforementioned automatic braking content CTpc, route guidance content CTrg, FCTA content CTta, and avoidance assistance content CTas. For example, each display rule can be applied to various types of content CT that can be displayed by the HUD 100, such as ACC content, LTC content, RSA (Road Sign Assist) content, and narrow road driving assistance content.

In addition, the shape, emission color, display position, and other attributes of the images for each content can be modified according to the driver's preferences. Furthermore, the application and non-application of each display rule may be selectable by the driver. For example, the number of colors, number of characters, character size, and the like that are allowed for display in the upper position VP2 may be adjustable. Furthermore, the language and unit types included in the text information MJ may be appropriately changed based on settings by a user such as the driver, as well as the country and region where the vehicle Am is used.

In a fourth modification, some or all of the processing functions of the head-up ECU 70 are implemented by the meter ECU 32 or another onboard ECU. In such forth modification, the system that includes the meter ECU 32 or another onboard ECU serves as the “virtual image display device.”

Furthermore, in a fifth modification of the above embodiment, some or all of the processing functions of the head-up ECU 70 are implemented in an integrated control device, such as a Human Machine Interface Control Unit (HCU). The processing functions of the meter ECU 32 may also be integrated into the HCU. In the fifth modification described above, the system that includes the HUD 100 and the HCU serves as the “virtual image display device.”

In the PGU 61 of the above embodiment, an EL (Electro Luminescence) panel may be provided instead of the LCD panel and backlight. Also, instead of the EL panel, a PGU 61 using a display device such as a plasma display panel, a cathode ray tube, and an LED may be employed. Furthermore, instead of the LCD panel and backlight, a laser projector or a DLP (Digital Light Processing, a registered trademark) and a screen may be provided. In the PGU 61 that employs such configuration, the display image on the screen is projected onto the windshield WS by the magnifying optical system 62 and forms a virtual image Vi. Additionally, the optical elements used in the magnifying optical system 62 are not limited to the concave mirror 62a and may be appropriately varied to include various mirrors, lenses, and holographic optical elements.

The processors provided in the head-up ECU 70 and the meter ECU 32 of the above embodiment are hardware for computation processing, coupled with RAM. Each of the processors includes at least one computation core, such as a CPU (Central Processing Unit) and a GPU (Graphics Processing Unit). The processor may also include an FPGA (Field-Programmable Gate Array) and other IP cores with specialized functions. On the other hand, the RAM may be configured to include video RAM for image generation. The processor executes various processes to realize the virtual image display method of the present disclosure by accessing the RAM.

The storage includes a non-volatile memory (non-transitory tangible storage medium). The storage of each ECU 32, 70 stores various programs (such as a display control program) that are executed by the processor. Such storage media are not limited to being provided on a circuit board, and may be provided in the form of memory cards or the like, which are inserted into slots and electrically connected to the control circuits of each ECU 32, 70. Furthermore, the storage media may be an optical disk or a hard disk drive, which serves as a source for copying or distributing programs to each ECU 32, 70.

In the above embodiment, the functions provided by the head-up ECU 70 and the meter ECU 32 can be implemented by software and the hardware executing the software, by software alone, by hardware alone, or by a combination of these. Furthermore, when such functions are provided by electronic circuits as hardware, each function can be implemented by digital circuits containing multiple logic circuits or by analog circuits.

The vehicle equipped with the above display system is not limited to general private passenger cars. The vehicle may be a rental car, a vehicle for a manned taxi, a ride-sharing vehicle, a cargo vehicle, and a bus. Additionally, the vehicle equipped with the display system may be a right-hand drive vehicle or a left-hand drive vehicle. Furthermore, the traffic environment in which the vehicle travels may be based on left-hand traffic or right-hand traffic. The display control according to the present disclosure may be appropriately optimized in accordance with the road traffic laws of each country and region, as well as the steering wheel position of the vehicle.

The control unit and its methods described in the present disclosure may be implemented by a dedicated computer that constitutes a processor programmed to execute one or more functions embodied by a computer program. Alternatively, the device and its methods described in the present disclosure may be implemented by dedicated hardware logic circuits. Alternatively, the device and its methods described in the present disclosure may be implemented by one or more dedicated computers composed of a combination of a processor executing a computer program and one or more hardware logic circuits. Additionally, the computer program may be stored on a computer-readable non-transitory tangible recording medium as instructions executed by a computer.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause the display control device to execute functions” includes the case where only the circuit causes the display control device to execute all the functions. Additionally, “at least one of a circuit and a processor is configured to cause the display control device to execute functions” includes the case where only the processor causes the display control device to execute all the functions. Furthermore, “at least one of a circuit and a processor is configured to cause the display control device to execute functions” includes the case where the circuit causes the display control device to execute some of the functions and the processor causes the display control device to execute the remaining functions. In the last case, for instance, if the display control device executes functions A to C, functions A and B may be implemented by the circuit, and the remaining function C may be implemented by the processor.

1. A virtual image display device configured to display a virtual image that is visible from an occupant in a vehicle, the virtual image display device comprising:
an actuator configured to switch a position of a display area between a first position and a second position which is upper than the first position, the display area being an area on which the virtual image is displayed; and
at least one of (i) a circuit and (ii) a processor with a memory storing computer program code executable by the processor, the at least one of the circuit and the processor being configured to display the virtual image of a corresponding content for each of the first position and the second position according to switching of the position of the display area by the actuator, the virtual image displayed in the position of the display area, other than the first position, following a display rule that is associated with at least one of a type of the content or the position of the display area, wherein
the content for the second position includes a filled background,
the at least one of the circuit and the processor is configured to limit a display duration of the filled background, based on the display rule, on displaying the filled background at the second position, and
the display duration is a duration during which the filled background is kept displayed.

2. The virtual image display device according to claim 1, wherein
the content for the second position further includes text information, and
the at least one of the circuit and the processor is configured to emphasize an outline of each character in the text information with a color different from a color of the filled background, based on the display rule, on displaying the text information on the filled background at the second position.

3. The virtual image display device according to claim 1, wherein
the content for the second position includes a notification content that informs about a risk target around the vehicle,
the at least one of the circuit and the processor is configured to set a non-display area in the second position, based on the display rule, on displaying the notification content at the second position, and
the non-display area is an area where the virtual image is not displayed in the display area.

4. A virtual image display device configured to display a virtual image that is visible from an occupant in a vehicle, the virtual image display device comprising:
an actuator configured to switch a position of a display area between a first position and a second position, the display area being an area on which the virtual image is displayed; and
at least one of (i) a circuit and (ii) a processor with a memory storing computer program code executable by the processor, the at least one of the circuit and the processor being configured to display the virtual image of a corresponding content for each of the first position and the second position according to switching of the position of the display area by the actuator, the virtual image displayed in the position of the display area, other than the first position, following a display rule that is associated with at least one of a type of the content or the position of the display area, wherein
the content for the second position includes a notification content that informs about a risk target around the vehicle,
the at least one of the circuit and the processor is configured to set a non-display area in the second position, based on the display rule, on displaying the notification content at the second position, and
the non-display area is an area where the virtual image is not displayed in the display area.

5. The virtual image display device according to claim 1, wherein
the content includes text information, and
the at least one of the circuit and the processor is configured to reduce at least one of a number of characters or a size of each character in the text information displayed at the second position compared to the text information displayed at the first position, based on the display rule.

6. The virtual image display device according to claim 1, wherein
the content includes a route guidance content that is used for a route guidance at a specified position, and
the at least one of the circuit and the processor is configured to change a mode of the route guidance content according to a distance from the vehicle to the specified position, based on the display rule.

7. The virtual image display device according to claim 1, wherein
the content for the second position includes a notification content that informs about a risk target around the vehicle, and
the at least one of the circuit and the processor is configured to limit a number of colors used for the virtual image at the second position compared to a number of colors used for the virtual image at the first position, based on the display rule, on displaying the notification content at the second position.

8. The virtual image display device according to claim 1, wherein
the content includes a notification content that informs about a risk target around the vehicle and a route guidance content used for a route guidance at a specified position, and
the at least one of the circuit and the processor is configured to differentiate the notification content from the route guidance content with different colors or shapes, based on the display rule.

9. The virtual image display device according to claim 1, wherein
the at least one of the circuit and the processor is configured to stop displaying the virtual image at the first position before the actuator moves the display area from the first position to the second position without the virtual image being displayed.

10. The virtual image display device according to claim 1, wherein
the content includes a common section that is common before and after movement of the display area from the first position to the second position, and
the at least one of the circuit and the processor is configured to adjust a display size of the virtual image of the common section while a relationship between the virtual image of the common section and a vanishing point in a foreground is maintained between the first position and the second position, based on the display rule.

11. The virtual image display device according to claim 1, wherein
the content includes a linear image section that extends toward a vanishing point in a foreground,
the linear image section is displayed both in the first position before movement of the display area and in the second position after the movement of the display area, and
the at least one of the circuit and the processor is configured to adjust a tilt of the linear image section while an orientation of the linear image section toward the vanishing point is maintained between the first position and the second position, based on the display rule.

12. A display control device configured to control, with interacting with a virtual image display device, display of a virtual image that is visible from an occupant in a vehicle, the display control device comprising
at least one of (i) a circuit and (ii) a processor with a memory storing computer program code executable by the processor, the at least one of the circuit and the processor being configured to cause the display control device to:
control the virtual image display device to display the virtual image and to switch a position of a display area between a first position and a second position that is upper than the first position, wherein
the display area is an area on which the virtual image is displayed,
the virtual image has a content that varies depending on whether the virtual image is displayed in the first position or the second position, and
the virtual image displayed in the position of the display area, other than the first position, follows a display rule that is associated with at least one of a type of the content or the position of the display area; and
limit a display duration of a filled background in the content at the second position based on the display rule, wherein
the display duration is a duration during which the filled background is kept displayed.

13. A display control device configured to control, with interacting with a virtual image display device, display of a virtual image that is visible from an occupant in a vehicle, the display control device comprising
at least one of (i) a circuit and (ii) a processor with a memory storing computer program code executable by the processor, the at least one of the circuit and the processor being configured to cause the display control device to:
control the virtual image display device to display the virtual image and to switch a position of a display area between a first position and a second position, wherein
the display area is an area on which the virtual image is displayed,
the virtual image has a content that varies depending on whether the virtual image is displayed in the first position or the second position, and
the virtual image displayed in the position of the display area, other than the first position, follows a display rule that is associated with at least one of a type of the content or the position of the display area; and
set a non-display area in the second position on displaying a notification content as the content at the second position, wherein
the notification content informs about a risk target around the vehicle, and
the non-display area is an area where the virtual image is not displayed in the display area.

14. The virtual image display device according to claim 7, wherein
the at least one of the circuit and the processor is configured to limit the number of colors used for the virtual image at the second position after the virtual image is moved from the first position to the second position.
